(19) United States
(12) Patent Application Publication
(10) Pub. No.: US 2009/0187471 A1
(43) Pub. Date: Jul. 23, 2009

(54) METHOD AND SYSTEM FOR EVALUATING ONE OR MORE ATTRIBUTES OF AN ORGANIZATION

(76) Inventors: George Ramsay Beaton, Armadale (AU); Margaret Ruth Beaton, Armadale (AU); Colin James Jasper, Brighton East (AU); Stefan Duncan Yelas, Auckland (NZ)

Correspondence Address: WINSTON & STRAWN LLP;PATENT DEPARTMENT, 1700 K STREET, N.W., WASHINGTON, DC, 20006, US

(21) Appl. No.: 12/278,314

(22) PCT Filed: Feb. 8, 2007
(86) PCT No.: PCT/AU2007/000129

§ 371 Date: Nov. 25, 2008

Related U.S. Application Data
(60) Provisional application No. 60/771,013, filed on Feb. 8, 2006.

(30) Foreign Application Priority Data
Feb. 8, 2006 (AU) 2006200538

(51) Int. Cl. G06Q 10/00

(52) U.S. Cl. 705/10

(57) ABSTRACT

A method of evaluating at least one attribute of an organization, by identifying at least one group of information holders, the group having at least one member who has information about the organization and at least one member who has information about at least one competitor of the organization, with the information about the organization and the competitor being related to the attribute; surveying a plurality of information holders within the group to seek responses comprising the information about the organization and the competitor, and analyzing the responses to produce an evaluation. A system for carrying out the method is also provided.

### CROSS REFERENCE TO RELATED APPLICATIONS

This application claims priority from U.S. Application 60/771,013, filed 8 Feb. 2006, the entire contents of which are incorporated herein by reference. This application also claims priority from Australian Application 2006200538 filed 8 Feb. 2006, the entire contents of which are incorporated by reference.

### FIELD OF THE INVENTION

The invention relates to methods and systems for evaluating an organization's attributes and the market from a third party perspective.

### BACKGROUND OF THE INVENTION

Organizations (also interchangeably referred to herein as “firms,” “companies,” “businesses,” and “groups”) can gain insight and significant improvements by better understanding the competitive environment in which they operate. However, it can be very difficult to obtain an objectively measurable assessment of this environment. The challenges to such an evaluation include the fact that repeat clients (also interchangeably referred to herein as “repeat customers,” or “customers”) are generally happy with the products or services they are obtaining. Buyers of products or services will naturally move their work away from organizations with which they are unhappy and so end up using those with which they are happy.

Thus if one asks clients whom they regard as the best organization for providing a particular product or service, they tend to name the organization they use the most, or sometimes simply the organization they are currently using. As a result, when organizations conduct research amongst their own clients, it generally provides a false sense of security, and in fact, unreliable and misleading information.

Furthermore, differences between organizations can often be hard to discern, as these differences are often largely intangible rather than based on distinctly different market offers. Such intangible aspects might for example relate to characteristics such as brand, service level and reputation. An assessment of differences between organizations would ideally include a focus on measuring such intangibles.

In addition, it is particularly difficult for clients to assess value when evaluating providers of services (in contrast to providers of products). Generally, the value and nature of services provided, are inherently intangible. It is often difficult for clients to assess value, even after the service has been delivered. For example, it is difficult to assess the value of a legal contract when it may never be tested. Furthermore, services are often largely personal, customized, and/or individualized, and so variability occurs, not just from one transaction to another, but also from one professional to another.

Professional service firms have another challenge in that they are often partnerships. To effectively implement a strategy requires that partners agree on that strategy. Not only are the partners the owners of the business, they are also the “engine room” responsible for managing and delivering the service. In general, most strategies will fail without the active support of each of the partners.

Traditionally, organizations have had the following options available to them to assess their performance in the context of the competitive environment: (1) do without research-sourced information; (2) conduct ad-hoc research; (3) use organization-conducted client surveys, and/or (4) rely on independent market studies, which can be sold to multiple firms.

(1) Do Without Research-Sourced Information.

This is prevalent among many organizations. While the obvious advantage is that the firm spends little, or no, money, there are numerous disadvantages. For example, the organization is likely to base its strategy on anecdotal, incomplete, and/or incorrect information, rather than research and data. Moreover, without research data which can serve as an objective source of direction, the organization may spend more time internally debating its current market position and strategic priorities. Additionally, the organization may not achieve consensus regarding its strategy which in turn, may undermine the strategy's implementation.

(2) Conduct Ad-Hoc Research

An organization may ask questions that are specific to its own strategy and the information obtained from the research can be seen confidentially by the organization without review by competitors, and, thus provide a competitive advantage. Ad-hoc research of this nature, however, can be expensive, as it is typically paid for in full by a single, commissioning organization. Furthermore, it is typically extremely difficult to obtain independent information about the organization and key competitors. As a result, most ad-hoc research focuses on a narrow set of issues and has a small, not infrequently biased, sample size.

(3) Use Organization-Conducted Client Surveys

Many organizations conduct their own research, for example, amongst their clients. This research usually involves customer and client interviews and/or customer satisfaction studies, and tend to focus directly on how to improve products and services for each customer. This option is particularly advantageous for providing relevant and accurate information on how to improve specific relationships. The key disadvantage of such a survey, however, is that it is a poor mechanism for understanding the firm's true position in the market. Therefore, this option typically has limited strategic value.

An example of a system for conducting surveys electronically is described in US Patent Publication Number 2005/0060219 to Deitering et at (“the '219 publication”). The '219 publication discloses that a segment of electronic survey results data, which is responsive to an indicator of business performance, may be extracted. In addition, the '219 publication states that the survey results may be benchmarked to or compared with other data such as external data and/or internal data that may be important for management and/or organization purposes. Importantly, however, the '219 publication does not disclose a method, system or apparatus for obtaining and analyzing independent information from a relevant group of information holders about an organization and its competitors. This is because the '219 publication does not disclose independent conduct of the study, nor independent sourcing of the information as the study is conducted by the organization itself, rather than a third parry entity. This detracts from the independence, accuracy, and/or objectivity of the evaluation.

(4) Rely on Independent Market Studies Sold to Multiple Firms

Independent market studies may be of different types. For example, some consulting firms offer benchmarks of financial performance. Generally, these studies have drawbacks, however. The comparative information is provided only from participating organizations, rather than benchmarked from the customer or client perspective. In some instances, the studies are focused on small-scale surveys, and consequently provide generic findings rather than information specific to individual organizations.

US Patent Application 2002/0165757 to Lisser (“the '757 publication”) describes a system for comparison of financial and operational performance of business entities by establishing a mathematical frame of reference based on data supplied by a group of entities, determining a rating value based upon the mathematical frame of reference and data for a first of the entities, and presenting the rating value to the first entity. According to the '757 publication, the data for the group of entities is not disclosed to the first entity and means are provided for normalizing the data so that different entities, such as entities selling different brands, can be compared. For each entity, performance indicator values are trended over time and compared to values associated with the other entities, to provide an indication of areas in which the entity can improve its performance and the value of improving the performance.

The information provided according to the '757 specification, however, is not independently generated, as it is supplied by the organization itself rather than its clients or entities that might one day be clients. Furthermore the method disclosed in the '757 publication docs not provide insight into attributes (and particularly not intangible, subjective attributes) that information holders (e.g., clients) have about the organization.

US Patent Application Number 2003/0149613 to Cohen et al. (“the '613 publication”) describes a computer-implemented method and system for assessing performance-related data for a preselected set of performers. According to the '613 application, performance measure data are received for performers as well as business logic rules that are related to at least one of the performance measures. A mathematical optimization program, which is constructed to include an overall performance rating as an objective function, is used to optimize the overall performance rating of the performers by adjusting a set of weights constrained by the business logic rules. The overall performance rating is used to assess the performance of the performers. In one example of the '613 publication, the Supplier Evaluation Risk (SER) is calculated. The SER predicts the likelihood of a firm ceasing business without paying all creditors in full and is derived from a Financial Stress Score that predicts the likelihood that a company will obtain relief from creditors or will reorganize over the next twelve months.

The '613 publication, however, has drawbacks. For example, the method of this invention is restricted to analysis of small sample sizes and does not provide insight into attributes, particularly intangible attributes, for which information holders, such as clients, have information about an organization.

There is a need in the organisation assessment field for a system and method to objectively, systematically, and reliably evaluate and predict business performance. More specifically, there is a need in the art for a system and method to provide an independent analysis of an organization from a customer or information holder perspective and in relation to intangible attributes.

The reference to any prior art in this specification is not, and should not be taken as an acknowledgement or any form of suggestion that the prior art forms part of the common general knowledge of the addressee of the specification.

### SUMMARY OF THE INVENTION

The present invention meets the needs of the art by providing methods of evaluating an organization from an independent, third party perspective that provide reliable, accurate, and systematic results.

One embodiment of the present invention encompasses a method of evaluating at least one attribute, for example a brand or service performance, of an organization that includes identifying at least one group of information holders. The group includes at least one member who has information about the organization and at least one member who has information about at least one competitor of the organization. The information about the organization and the competitor is related to the attribute. Moreover, the method includes the step of surveying a plurality of information holders within the group to seek responses including the information about the organization and the competitor. In preferred embodiments, at least the surveying step is performed electronically. Additionally, the method includes analyzing information from the responses to produce an evaluation of the attribute.

In one embodiment, there is provided a method of evaluating at least one attribute of an organization, comprising: identifying at least one group of information holders, the group having at least one member who has information about the organization and at least one member who has information about at least one competitor of the organization, wherein the information about the organization and the competitor is related to the attribute, surveying a plurality of information holders within the group to seek responses comprising the information about the organization and the competitor; and analyzing the responses to produce an evaluation. As used herein, ‘evaluation’ means an analysis of data collected, for example in a survey in accordance with the invention. Thus, it comprises more than simply the survey data in unanalyzed form.

The evaluation may be undertaken completely independently of any request from the organization evaluated. In some embodiments, information about a plurality of organizations may be gathered in a survey and one or more of the organizations may then be evaluated based on the data collected. An evaluation may be offered and provided preferably for value to one or more of such organizations, such as for example, after the survey has been conducted but before the evaluation has been completed, or after the evaluation has been completed. In some embodiments, the data comprising the survey results may later be analysed in order to provide an evaluation to a further organization or, indeed further analysis may be conducted to further evaluate an organization.

The method may further comprise the step of surveying a plurality of information holders within the group in relation to an environmental attribute relevant to the organization. There may also be a step of providing an award competition for a plurality of organizations in which said awards are based on the results of one or more evaluations according to the invention. In one embodiment, the method is used to evaluate a professional service firm. In some embodiments, the analyzing step comprises comparing information received about the organization with that received in relation to at least one competitor.

In another embodiment, there is provided a method of evaluating at least one environmental attribute relevant to an organization, comprising: identifying at least one group of information holders, the group having at least one member who has information about the organization and at least one member who has information about at least one competitor of the organization, wherein the information about the organization and the competitor is related to the environmental attribute; surveying a plurality of information holders within the group to obtain responses including the information about the organization and the competitor; and analyzing the responses to produce an evaluation.

The method of the invention may further comprise an award competition for a plurality of organisations in which said awards are based on one or more evaluations according to the invention. Furthermore, one or more of the identifying, surveying and analyzing steps are performed electronically.

In another embodiment, there is provided a system or apparatus for evaluating at least one attribute of an organization comprising: a memory system for Storing information associated with the evaluation; a survey system to conduct a survey of identified information holders; an analysis system to analyse survey responses to produce an evaluation; and optionally a communication system to communicate one or more results of the evaluation to the organization. The system or apparatus may further comprise a processing system capable of identifying at least one group of information holders and the memory system may comprise a hard disk on a computer in communication with the processing system; and the survey system may comprise an internet website and underlying software.

Any of the embodiments illustrated herein stand independently, and any features or embodiments may be combined in any way, unless expressly excluded, to achieve a preferred embodiment. Additional advantages and embodiments of the invention will also become more apparent to those of ordinary skill in the art upon review of the teachings of the description of the preferred embodiments, and from the claims.

Throughout this specification (including any claims which follow), unless the context requires otherwise, the word ‘comprise’, and variations such as ‘comprises’ or ‘comprising’, will be understood to imply the inclusion of a stated integer or step or group of integers or steps but not the exclusion of any other integer or step or group of integers or steps.

### BRIEF DESCRIPTION OR THE DRAWINGS

Further advantageous features of the present invention will become more apparent with the following detailed description when taken with reference to the accompanying drawings in which:

FIG. 1 is a schematic representation of the relationships that may exist between various entities participating in an evaluation and a consulting firm, according to one preferred embodiment of the invention;

FIG. 2 is a schematic representation of the relationships between various entities participating in one preferred embodiment of the invention from the perspective of databases, research and outputs;

FIG. 3 is a schematic representation of a potential under lying growth model of the preferred embodiment, according depicted in FIG. 1;

FIG. 4 illustrates the elements and outcomes of the Examples that are based on the growth model depicted in FIG. 3;

FIG. 5 is a block diagram of the components of a system or apparatus, according to one preferred embodiment of the invention;

FIG. 6 is a flowchart of a routine implementing an example method, according to one preferred embodiment of the invention;

FIG. 7 presents hardware, software or a combination thereof that may be implemented in one or more computer systems or other processing systems to carry out the functionality, of the present invention, in accordance with one embodiment of the present invention; and

FIG. 8 presents an exemplary system diagram of various hardware components and other features, in accordance with an embodiment of the present invention.

### DESCRIPTION OF EXAMPLE EMBODIMENTS

As used herein, “attributes” are factors which relate in some way to the success of the organization. Attributes may include either organizational attributes or environmental attributes, as defined herein. The invention may be used to evaluate a single or multiple attributes.

As used herein, “organizational attributes” are characteristics of an organization which relate in some way to success of the organization and are able to be influenced by the organization. For example, an organizational attribute may relate to marketing, brand, perception of brand, perception of the organization in the marketplace, technical performance, customer satisfaction, quality of products or services, environmental impact, ethical standards, human resources management, financial performance, social impact, client service, innovation, strategy, implementation, etc. In some embodiments, organizational attributes are subjective aspects of the organization, and include for example, reputation and/or service level. Any organizational attribute of an organization may be evaluated according to the method of the invention. The invention may be used to evaluate a single or multiple organizational attributes.

As used herein, “environmental attributes” are characteristics of an organization's environment which relate in some way to success of the organization over which the organization will in general have little influence, if any. While it is possible that an environmental attribute may be in some way related to an organizational attribute, this does not need to be the case. An environmental attribute is an influence from the general environment within which the organization operates that in some way affects it and about which the organization should be aware. In contrast, an organizational attribute is an internal characteristic of an organization. For example, an environmental attribute may relate to industry insight, such as trends in the industry in which the organization operates, or trends amongst its clients. Environmental attributes may include for example, issues of most concern to an industry, predictions about the direction in which the industry is headed, and significant opportunities that are identified for the industry. Such information is particularly useful for the assessment of organizational attributes of the organization when the information is related to an industry in which one or more of the organization's clients operates. This is because such an assessment can be beneficial in selecting future product or service offerings to current and prospective clients. In some embodiments, an environmental attribute to be evaluated is buyer behavior with respect to entities that typically buy products or services from the organization and/or its competitors.

As used herein, “information holders” are individuals, groups, or organizations that have at least some connection with the organization or the field in which the organization operates. The connection itself may be slight, but it will be sufficient so as to enable the information holders) to provide an opinion in relation to an organisational attribute or environmental attribute and thus assist with an evaluation. Information holders are chosen depending on the organizational attribute or environmental attribute to be evaluated.

The following examples are not intended to be limiting; but to provide further context. One group of information holders might fur example include individuals, groups, or business entities that are related to the business of the organization, for example, when surveying for information related to the organizational attribute of perception of brand or the environmental attribute of industry insight. In some embodiments, information holders are potential or actual recipients of the organization's services and/or goods, such as selecting individuals with insurance to be surveyed regarding the environmental attribute of the direction of the insurance industry. In some embodiments, information holders are the focus of marketing for the organization, for example, viewers or listeners of commercial media can be chosen when collecting survey information on the organizational attribute of brand loyalty. In other embodiments, information holders are clients, consumers, or customers of the organization, for example, customer can be chosen when collecting survey information on the attribute of perception of brand. In an embodiment in which an attribute relating to human resources is evaluated, the information holders may be employees or a subset thereof, and the attribute may be employee satisfaction, for example. According to one preferred embodiment, a plurality of groups of information holders is identified as a source of information holders to survey.

Another group of information holders can include individuals, groups, or entities associated with the organization. Thus, for example, information holders may be current or ex-members (or employees) of the organization, categories of employees, directors, managers, partners, shareholders, etc. Unrelated information holders may include for example current, potential or ex-clients, industry organizations, business partners (such as collaborators, joint venture partners or licensees), the media, government or regulatory bodies (including complaints-handling bodies), the organization's competitors, entities or people with interests in issues relevant to the organization including environmental or social issues etc.

According to some embodiments, members of one or more government bodies that regularly deal with the organization are identified as information holders and surveyed as part of the method of the invention. According to this embodiment, attributes such as effectiveness of dealings with the government body may be evaluated. Such an evaluation may be particularly useful to assess the effectiveness of individuals and organizations such as accountants dealing with the tax office, patent attorneys dealing with the patent office, or regulatory consultants dealing with a regulatory body (such as the relevant Food & Drug Administration), etc.

According to another embodiment, one or more complaint-handling bodies are preferably identified as information holders and surveyed as part of the method of the invention. According to this embodiment information about certain negative aspects of the organization may be identified. Such aspects may relate to any suitable attribute, for example product quality (and product recalls), compliance with international standards, complaints by customers or professional service firm clients, etc. In a similar embodiment, one or more consumer groups are identified as information holders and surveyed as part of the method of the invention. Such consumer groups may provide either positive or negative assessments in relation to one or more attributes.

According to yet another embodiment, a group of competitors are identified as information holders and surveyed as part of the method of the invention. According to this embodiment, an organization can compare perception in the market not only by clients, but also by its competitors. Such information can provide insights into future strategy of the company.

The information holders can be defined, for example, by a particular characteristic. Such a characteristic may relate to a demographic, such as gender, age, geographical location, type of entity, etc. Thus for example, information holders surveyed as part of the method of the invention may be restricted to only those in particular geographical locations, or countries, or in particular market segments, or with interests in particular environmental or social issues.

In one embodiment, information holders have information about one or more aspects regarding the organization's services, products, or a combination thereof. For example, such groups may be industry groups or subgroups, or may be defined by a particular need (for example, the need for a particular product or service).

Identification of information holders and groups of information holders according to the present invention may be done by any suitable means, as would be understood by one skilled in the art. For example, identification may be conducted by analysis of directories of information holders or of a database or a list of information holders that may be provided by the organization under evaluation. According to an embodiment of the invention, a group of information holders is identified by first considering the attributes (whether organizational or environmental) to be evaluated, and second, searching for and identifying groups of information holders relevant to those attributes. According to another embodiment in which multiple organizations are evaluated in a single survey, each organization is asked to supply a list of clients to be invited to participate in the survey. According to some embodiments, the organizations are professional service firms that are invited to supply client lists.

As used herein, an “independent” party, associated with the evaluation, is defined as a party that is unrelated to the organization being evaluated. In certain embodiments, the independent parry is a consulting firm (also interchangeably referred to herein as a “consulting group” or “consultant” in the singular) that provides services to the organisation.

As used herein, a “competitive situation” is defined as the organization's business position with respect to at least one of its competitors. In preferred embodiments, competitive situation implies profitability, sustain ability, market share, viability, growth potential, human capital, capital, business performance, or a combination thereof.

A benefit or the present invention is that the validity of the evaluation is strengthened through greater levels of independence. Two important dimensions to independence that are created with evaluations according to certain embodiments of the present invention include: 1) the names of information holders, such as clients contacted for the research, may be obtained without the involvement of the organization(s) that is/are the subjects) of the evaluation, and 2) the research may be designed and conducted by a third-party. An evaluation according to the present invention may, of course be independent in either one of or both of these ways.

As used herein, interested parties may include individuals, groups, and/or entities that have a concern and/or interest (e.g., financial), preferably a vested interested, and more preferably direct or indirect governance (e.g., business partner), in the organization that is evaluated.

The method of the present invention is directed to evaluating organizational attributes and/or environmental attributes of, about, or related to any organization, preferably an organization that interacts with people or entities outside the organization. In one embodiment the method may be used to evaluate attributes of companies that provide products to clients. In another embodiment, the present invention is applicable to evaluate attributes of an organization providing services, for example “professional service firms,” such as those in legal, accounting, engineering, management consulting, information technology (IT) professions, or those in advertising or training fields. Additionally, the method is also preferably applicable to many other types of organizations that provide services, such as industrial services (e.g., transport, telecommunications, or cleaning) or financial services (e.g., banking or insurance), or pharmaceutical companies and healthcare professionals; medical equipment and services to hospitals and healthcare facilities, ingredients and component suppliers to manufacturers of all types of goods, such as suppliers of office goods and services. In certain embodiments, organization types may include not-for profit organizations or government agencies.

According to one embodiment, attributes are analyzed in relation to organizations that do not provide products or services principally directed at personal use or consumption by consumers in their private capacities. Examples of such products or services include packaged groceries, personal care and grooming, home appliances, retail stores, retail banking, automobiles, related services etc. In one embodiment, attributes are analyzed in relation to organizations that provide products or services to other businesses, such as business-to-business (B2B) organizations.

A further benefit of the method of the invention is that the organization under evaluation need not participate in the evaluation. Thus, it is possible to obtain an evaluation of an attribute of an organization without requiring consent from that organization. According to one additional embodiment, multiple organizations from a series of market segments are evaluated in a single large evaluation. In yet another embodiment, the evaluation concerns organizations from multiple industries or areas which may have one or more information holders or groups of information holders in common. Thus, for example, in one embodiment, the evaluation concerns professional service firms from numerous disciplines, such as legal, accounting, patent attorney, engineering, management consulting, IT etc.

According to some embodiments, the evaluation comprises an analysis of more than one organizational attribute of the organization or environmental attribute relevant to the organization or a combination thereof. In one embodiment, the evaluation comprises analysis of the organizational attributes of brand and performance and the environmental attribute of buyer behavior. Preferably, subcategories of each organizational attribute and/or environmental attribute are assessed as part of the evaluation, and preferably a detailed evaluation of each subcategory is produced. Thus for example, subcategories of the ‘buyer behavior’ environmental attribute (which assesses characteristics of potential buyers of services offered by organization(s) under evaluation) include, decision-making processes, drivers of choice, loyalty, performance, value, referral and switching; brand covers awareness, associations, attitudes, consideration and differentiation (including benchmarks) and ‘decision-making unit’ (clarification of the nature of the purchasing decision-making body within potential buyers of services) and decision-making process. Similarly, sub-categories of the organizational attribute of performance include overall performance and also component parts, such as technical expertise, responsiveness, commerciality of advice, geographic coverage, etc. (as tailored to specific professions).

The evaluation conducted is optimally designed to create an opportunity for improvement by the organization. Improvement may be in any relevant, measurable or calculable manner. However, it will often relate directly to performance in an attribute analyzed as part of the evaluation. According to certain embodiments, the evaluation is designed to assist the organization to improve performance and/or identify growth opportunities. Preferably the evaluation comprises comparisons with other relevant data. Such comparisons may be of any relevant type. For example, the comparison may be with state, national, regional or international benchmarks that may relate to a particular industry or benchmarks identified during the survey.

A comparison, according to the present invention, may involve historical information about the organization or the industry or information holders, or clients that may, for example, have been gathered during previous evaluations conducted according to the invention.

An evaluation, according to the present invention, may be of any suitable type, include any description, and of any content, so long as it provides output that is useful for the organization. In a certain embodiment, the evaluation is based on quantitative results that are generated from analysis of the survey results. A survey instrument can be created so as to provide quantitative raw data for analysis.

An evaluation according to the present invention may be provided to the organization in question (i.e., the organization being evaluated). In most embodiments, a third party evaluation of the industry would be provided pursuant to a request by the organization and relevant commercial terms, such as payment, confidentiality etc. In preferred embodiments, the participating organizations receive the results of the evaluation. In some embodiments, at least one evaluated organization among the group of organizations declines to acquire (e.g., purchase) the evaluation.

An evaluation according to the present invention may be provided in any suitable form, including hard copy, electronic, online, face-to-face or online workshop, etc. According to an embodiment, organizations may elect to obtain an evaluation as a report or workshop or a combination of both. Thus, for example, a client or customer workshop and or consulting services based on the results of the evaluation may be provided. According to another embodiment, the organization may license some or all of the raw data pertaining to itself and utilize proprietary tools to further analyze the data. Such tools may be provided in any suitable form, for example they may be provided online via the Internet, or on a digital medium, such as a CD, or by any other suitable method.

Preferably, the evaluation comprises benchmarking, preferably from the information holder perspective. As used herein, benchmarking encompasses baseline value or statistics for the company or industry, for example. Generally, the term benchmark is used with its definition commonly understood in the art. For example, benchmarks are generally used as reference statistics to characterize the organization's future, ongoing, or comparative performance. Benchmarking may be from the perspective of a customer or client of the organization. In another embodiment, the evaluation provides useful information that is specifically relevant to the organization and which is statistically valid and of high quality.

A system for conducting the evaluation, in accordance with the method of the present invention, may conduct the survey in any suitable manner. Thus, for example, the evaluation may be conducted manually and/or in hard copy. Preferably, conduct of the survey, and various methods of the present invention, may be partially or wholly automated on software or a computer readable program, for example. Additionally, the survey, the survey responses, and/or the evaluation may be provided to more than one end-user over a computer network, such as the Internet and/or local area network, for example.

The instrument of the survey will be created to suit the purposes of the evaluation, as would be understood by one skilled in the art. According to one embodiment, the instrument is created based on feedback from organizations, information holders and other interested parties. Such feedback may be provided at any suitable time, preferably at a time that provides valuable information for the survey. For example, it may be provided in light of a previous evaluation or as part of a specific information gathering exercise such as a focus group. In some embodiments, the survey is conducted after, preferably a short time after, and more preferably immediately after, the organization provided a service to the client, who provides the survey response.

Analysis of survey responses according to the invention may be done by any suitable means, as would be understood by one skilled in the art. For example, a suitably qualified person/entity may review the survey manually, or preferably may be assisted in some way by computer, or more preferably, the survey may be completely automated. Those skilled in the art would appreciate that standard statistical techniques may be used to analyze and evaluate the survey responses and that such techniques are typically at least partially implemented with the assistance of a computer. In one embodiment of the invention, the entire analysis of survey responses is conducted by computer.

According to one more embodiment, the survey results are compared with a pre-estimate performed by the organization prior to receiving the survey results or the evaluation. For instance, pre-estimate numbers may be results desired by the organization. Moreover, the survey analysis results may be compared with goals that have been set by the organization. Any suitable method, may be used to generate such a comparison. For example, an organization may generate a set of goals that are characterized in quantitative terms and a later survey instrument is created to measure these terms thus enabling an assessment of the relative achievement of the goals. Such a comparison is useful for example to enable the organization to analyze and measure the gap between its assessment of performance for a given organizational attribute or environmental attribute, and the current state of affairs.

The method of the invention may be conducted by any person or entity, skilled in the art, whether inside or outside the organization in question, for example, a consultant to the organization.

According to still yet another embodiment of the invention, an award competition for a plurality of organizations may be established. The awards may be based on any suitable characteristic, for example improvements (e.g., exceeding expectations from the benchmark) on one or more evaluations according to the invention, for example.

An award competition may be used in association with the evaluation methods of the present invention, for example as a method of promoting the completion of the evaluation, encouraging participation by organizations and/or information holders, generating interest in the evaluation process, and/or recognizing the achievements of the organization (or conversely, highlighting the lack of performance of poor-performing organization). In certain embodiments, by running such a competition in conjunction with an evaluation according to the invention, it is possible to gain further advantages, such as increasing the number of participant information holders to be surveyed, increasing the number of organizations evaluated, and increasing the profile and revenue of the entity running the competition, etc.

It will be appreciated that the competition may be run in any suitable way, as would be understood to one skilled in the art. For example, entry into the competition may be optionally limited to only organizations that have committed to obtaining an evaluation. Alternatively, the competition may be unlimited (i.e., open) to any organization. Either of these methods may potentially increase the number of organizations that commit to obtain an evaluation. The awards according to this aspect of the invention may be based on, for example, the rankings, performance, or scores, of one or more attributes or a combination of certain attributes evaluated.

The competition may be governed by, or in conjunction with, any suitable entity. Thus for example, in some embodiments, the competition is governed in conjunction with an entity which is within, related to, in the same industry, or a related or unrelated industry of the organization seeking to increase performance. For example, the awards may be presented by a consulting firm and/or a media enterprise (e.g., a media outlet reporting the competition or results thereof) either alone or one in association with the other. For example, a consulting firm or media enterprise may host, judge, sponsor, tabulate the results of, and/or broadcast an awards competition. The awards competition may be intra-division or inter-division of the company, intra-company or inter-company, intra-sector or inter-sector of the market or industry, or intra-industry or inter-industry.

In embodiments, there is provided a method of generating revenue for a media enterprise comprising running an organization award competition in association with an evaluation method, system or apparatus according to the invention. With the evaluation method of the present invention it is possible to substantially increase revenue, for example, by increasing market intelligence and profile building, networking and service offerings to the general business community via the associated award competition conducted in accordance with the present invention. Other benefits to a media enterprise which may arise from the invention include: generating additional content for sale to subscribers, increased profile and associated sales of media content which details award competition results and analysis, sponsorship revenue for the award ceremony and competition, and publicity.

In another embodiment of the invention, there is provided system or apparatus for evaluating at least one attribute of ail organisation comprising: a memory system for storing collected information associated with the evaluation; a survey system to conduct a survey of identified information holders, for example by emailing or mailing questionnaires to information holders or providing an online site to collect information; an analysis system to analyse survey responses to produce an evaluation, such as including statistical analysis software; and optionally a communication system to communicate one or more results of the evaluation to the organization, such as the internet.

The system or apparatus may further comprise a processing system capable of identifying at least one group of information holders. Configuration of the system or apparatus according to this embodiment may for example comprise a database, stored on a memory, of groups of potentially useful information holders. The database may be populated using information from known sources of pre-collected information relating to information holders. Such sources of pre-collected information may for example include as trade associations, regulatory bodies, etc. The database may additionally link each information holder or group of information holders to one or more types of information relevant to one or more attributes. By way of example only, a database may include lists of attorneys working as in-house counsel within the top 1000 corporations in a particular geographical location, such as a country. A processing system according to the present invention may search the database for attorneys working in corporations within a particular industry segment in order to identify information holders with information relevant to the attribute of brand perception of law firms in that industry.

In a further embodiment, the memory system comprises a hard disk on a computer in communication with the processing system; and the survey system comprises an internet website and underlying software.

A memory system according to the invention may be any suitable type suitable for storing information to conduct the method of the invention. Preferably it comprises a hard disk on a computer. A processing system according to this aspect of the invention may be of any suitable type. The memory system and processing system may be in communication by any suitable method, including by way of example, direct electronic connection, connection over a network, wireless connection, etc. The means by which the processing system may identify at least one group of information holders may be any suitable means. For example, it may involve analysis of data in a database according to predetermined criteria, as would generally be known by those skilled in the art.

A survey system according to the present invention may be of any suitable type depending on the degree to which the survey is conducted by computer. Thus, according to some embodiments the entire survey is conducted by computer, in which case the survey system may for example include an internet website and underlying software and the underlying survey instrument in electronic form. Optionally, a survey system may comprise means to automate interaction with survey responders. Thus, for example, it may react to certain new information, such as by replying with a computer-generated email to a responder or by choosing a question or set of questions to be answered by the respondent based on the answer to at least one previous question.

An analysis system according to the invention may comprise any suitable hardware and/or software capable of conducting an analysis according to the method of the invention. A communication system according to the invention may comprise any suitable hardware and/or software capable of communicating in accordance with the method of the invention. According to one preferred embodiment, the communication system comprises means to create and forward an electronic document by email (which may be in any suitable form, for example, in PDF format manufactured by Adobe Systems Inc., San Jose, Calif., USA).

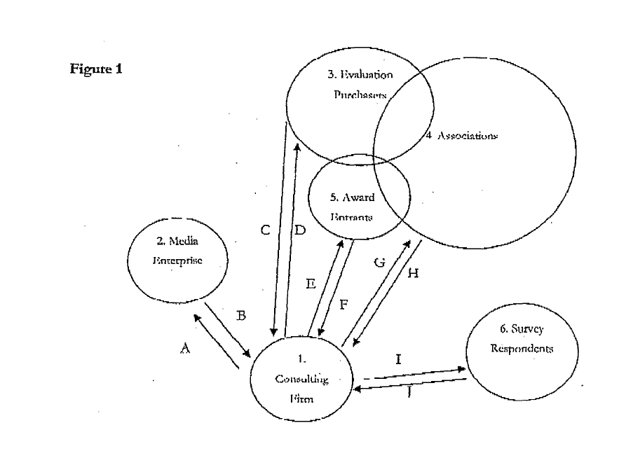

According to one embodiment, depicted in FIG. 1, a consulting firm 1, conducts an evaluation according to the present invention in relation to multiple attributes of numerous professional service firms from five professions in association with a media enterprise 2, which positions itself as providing relevant content to the business community via a weekly hard copy magazine supplemented with online content.

The evaluation according to this embodiment of the invention is conducted in a single survey study that covers the evaluation categories of buyer behavior (an environmental attribute), brand and performance (both organizational attributes) of professional service firms. For instance, in this example, buyer behavior covers decision-making unit, decision-making processes, drivers of choice, loyalty, performance, value, referral and switching; brand covers awareness, associations, attitudes, consideration and differentiation (including benchmarks); and performance covers overall performance and also component parts, such as technical expertise, responsiveness, commerciality of advice, geographic coverage, etc, (as tailored to specific professions). Outcome variables such as loyalty and referral are included as are measures of fees and value. All of these are benchmarked against key competitors.

Demographic data allow responses to be stratified into many sub-categories (e.g., segments), including by firm size, by respondent position, by location, for example, that allows more refined analysis of data. It is preferred that the evaluation is tailored (e.g., re-designed), in a timely fashion, such as annually, to maintain the key benchmarking features and the relevant environmental attributes, thereby ensuring the evaluation's usefulness and relevancy over time, and preferably improving the evaluation each time it is conducted.

In one embodiment, the media enterprise runs an award competition (also interchangeably referred to herein as “awards” or “competition”) in conjunction with the consulting firm. The media enterprise provides promotion, publishes a special edition for the awards, organizes the awards night and arranges sponsorship while the consulting firm provides the results and manages relations with entrants. The media enterprise also provides the consulting firm with access to its appropriate databases (e.g., its subscriber database) for the purpose of identifying potential survey respondents 6.

In certain embodiments, the promotion of the awards includes many weeks of advertisements, including, for example, in the media enterprise's magazine, space on the media enterprise's website to explain the awards (including how to enter) and a special edition of the magazine which is focused on the winners of the awards. The awards ceremony is held at a special dinner in which the winners are announced ahead of the special issue. Although it is not depicted, there is a sponsorship arrangement with a corporate sponsor that provides the media enterprise with additional funding in return for co-branding of the awards. The benefits A to the media enterprise of participating include: content for the magazine; sales of magazines; sponsorship revenue from the corporate sponsor; positioning as the magazine most closely associated with the professions; and publicity generated by the awards.

The benefits B that the media enterprise provides to the consulting firm may include, for example: promotion of the consulting firm in the special issue; promotion on website and in print while promoting the awards; access to appropriate databases for further survey respondents 6; and provision of an incentive for a broad range of firms (evaluation purchasers 3), from a broad range of professions, to provide their client databases C to identify further survey respondents 6 for the survey component of the invention.

In some embodiments, it is contemplated that any professional service firm of a predetermined size that is operating in a chosen geographical area and in one of the professions that are the subject of the survey may enter the awards. White it is expected that some of such award entrants 5 will also purchase an evaluation 3 and be members of an industry association 4, this is not required for entry into the awards. Professional service firms from the five chosen disciplines are encouraged to enter the awards to access benefits E, which may include: the possibility of winning, which includes the further benefits include enhanced promotion and better credentials when approaching prospective clients; and a free report from the study, which provides an overview summary that is distinct from an evaluation according to the invention and provides general information on the awards and a little information on the firm's performance.

In exchange, firms provide the following benefits to the consulting firm F; a database of no less than a predetermined number of client names and email addresses used both to determine the winners of the awards and to collect data for the evaluation (the winners are selected based on answers to questions forming part of the survey and evaluation); a set entry fee; sales leads for evaluation reports and other consulting services.

Purchasers of an evaluation according to the present invention 3 may purchase a variety of reports and packages depending on their specific needs. Various dimensions of the reports might include: profession-specific reports; geographical reports; and research area, for example buyer behavior, brand awareness, brand associations brand attitude and performance.

Firms are also invited to submit client databases for use in the research. The benefit to the firms is that this enables greater intra-firm benchmarking (i.e., at an office and practice group level) than would otherwise be possible.

The benefits to firms D of purchasing an evaluation include, for example: access to large scale, independent research amongst clients and prospects including access to information on organizational attributes and environmental attributes such as how clients buy, how the firm is positioned in the market and how its performance compares to competitors; providing quantified market based strategic information rather than opinions and anecdotes; and a mandate (and imperative) to action by the senior management team.

The benefits that firms provide to the consulting firm C are: revenue through the purchase of evaluation reports; client databases for the study; input into the following year's questionnaire design (through user groups); and cross-selling (also interchangeably known in the art as “cross-marketing”) opportunities, i.e., firms buy an evaluation and then may use the consulting firm for other services.

Professional Associations 4 participate in the process. Benefits to associations G include: a free member survey; free journal articles; free tickets to the awards dinner; participation in a community-minded project to improve the standards of client service in professional service firms; and recognition of support in the media enterprise's magazine, regarding evaluation reports and on the consulting firm and media enterprise websites.

The benefits H that Associations provide to the consulting firm include: databases for the study; credibility by allowing the use of their logo and name; introduction to other associations who could potentially provide the above benefits; and some input into the questions used in the survey.

Once the email invitations to survey respondents 6 are distributed (typically many tens or hundreds of thousands may be distributed), invitees have the choice to respond. Several incentives J are offered to invitees to encourage responses: a prize incentive; a free report from the study; input into surveys run by associations they may be a member of; and intangible community benefits such as better client service from professional service firms.

Consulting firm 1 obtains numerous benefits from operating the present invention according to this embodiment, including: revenue generated from selling evaluation reports: access to new markets—through associations and entrants into the awards; brand building—through the promotional value of the awards; and relationships with key information holders—including firms, the media and associations.

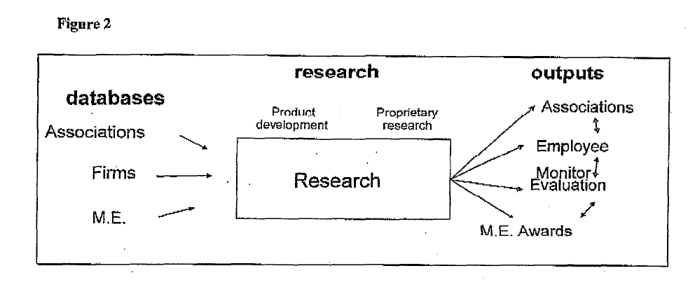

FIG. 2 further provides an overview of the interactions between entities in the embodiment depicted in FIG. 1 of the method according to the present invention. To begin, associations, firms and the media enterprise (M.E.) all submit databases to the consulting firm. These databases contain email addresses of potential clients of the professional service firms. These databases form the sample of people invited to participate in the survey used in the research. Employee Monitor is an output that provides information in relation to the attitudes and perceptions of current and prospective employees of professional service firms.

The research generally involves sending each email address a unique hyperlink to an online study. Invitations and reminders are sent, and responses are collected. The responses are aggregated and analyzed to produce the evaluation, results for the awards, respondent reports, award entrant reports, and association reports.

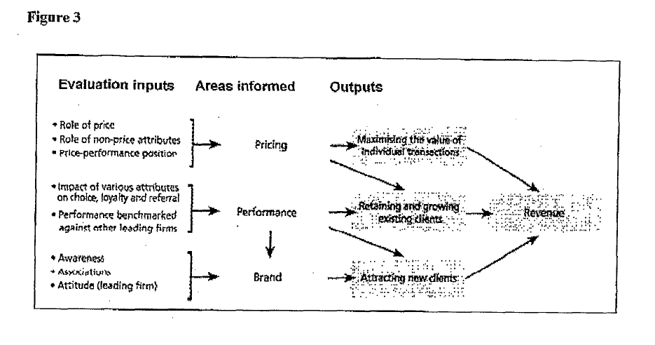

FIG. 3 represents the growth model for the strategic information provided to firms in an evaluation according to the embodiment depicted in FIG. 1. The starting point is that there are three ways to increase revenue (outputs): by maximizing value of individual transactions (e.g., raising prices); by retaining and growing existing clients; and by attracting new clients.

The “areas informed” elements help achieve these three outputs. For example, improving a firm's brand will help attract new clients. The “evaluation inputs” element shows what an evaluation according to this embodiment explores, and how that feeds into the “areas informed.” For example, an evaluation explores brand awareness, associations and attitude that in combination define a firm's brand strength and opportunities for improvement.

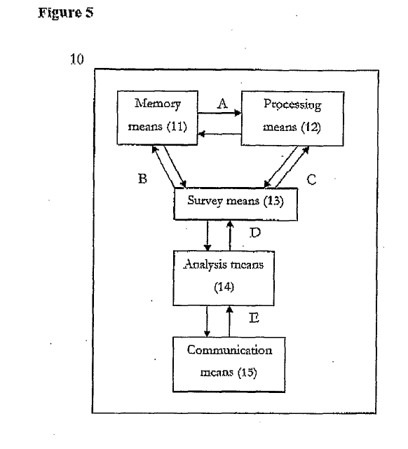

FIG. 5 is a block diagram of the components of a system or apparatus according to the invention depicted generally at 10. A memory means (e.g., memory system) 11 is for storing information about information holders, groups of information holders and organizations that the information holders may have information about. A processing means (e.g., processing system) 12 communicates A′ with memory system 11 via a standard connection. The processing means (e.g., processing system) is capable of identifying at least one group of information holders, one or members of the group having information about the organization and one or members of the group having information about one or more of the organization's competitors. Survey means (e.g., survey system) 13 enables conduct of a survey of said identified information holders in relation to (a) the organization's performance in the attribute and (b) the performance in the attribute of one or more of its competitors. A survey system 13 communicates B′ with memory system 11 in relation to information about organizations, information holders and groups of information holders, and communicates C with processing system 12 in relation to identified information holders to survey. An analysis means (e.g., analysis system) 14 analyzes survey responses to produce an evaluation and communicates D with the survey system 13 in relation to the results of the survey. A communication means (e.g., communication system) 15 is in communication E with the analysis means 14 and communicates one or more results of the evaluation to at least one organization.

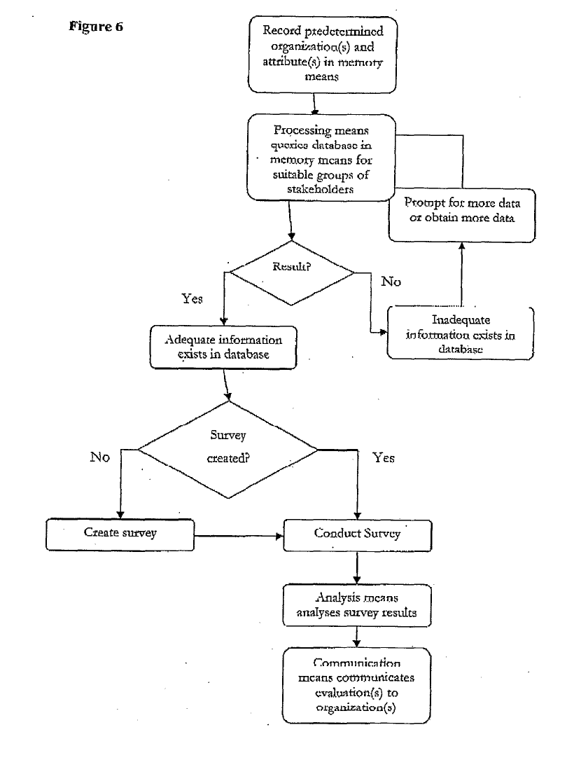

FIG. 6 is a flowchart of a routine that implements an example method according to the present invention.

Some of the advantages of this particular embodiment are related to pricing, brand, attracting clients, retaining and growing clients, focusing strategic efforts, implementation problems, and lead indicator valve of beacon. Pricing includes knowing how much to charge clients is critical to maximizing profit today. The present invention illuminates the true client perceptions of price, allowing an organization to discover how the firm's price is perceived compared to others, thereby determined whether and by how much to increase price.

Brand includes improving the strength of the brand in the market and is critical to the firm's growth. The invention's brand data helps determine the status of the brand today, while the workshop helps define the way forward and set a strong action plan towards strengthening the brand in target markets.

Attracting clients includes getting better at bringing in good quality clients and is critical to growing the firm. An evaluation according to the invention reveals what potential clients look for in a firm, examines the link between marketing activities and getting into the consideration set and what your word-of-mouth referrals are likely to be, which means that you can target your marketing and client service strategies to attract more and/or better clients.

Retaining and growing clients involves getting better at keeping and growing existing clients in order to maximize profits and grow the firm. An evaluation according to the invention shows what one would need to do differently to retain happy clients, and what things impact most on loyalty, which means that one can target marketing and client service strategies to retain and grow one's best clients.

Focusing strategic efforts involves identifying key strategic areas and creating focus on them. The invention facilitates identification of the strategic areas the company must focus on, and the workshop will help define a handful of key strategic priorities. Consequently, the company regains control of its strategic agenda, and is able to successfully implement those things that are central to the company's profit and growth.

Implementation problems sometimes arise as a result of difficulties in getting senior management, such as partners in a professional service firm, to ‘buy-in’ to and participate in the organization's strategy. The method and system of the invention assists to ameliorate these problems by providing unbiased, factual evidence, that is very difficult to dispute. Workshops are designed to stimulate discussion and ownership on a way forward. That is, senior managers or principals end up believing in the strategy and commit to implementing it.

The ‘lead indicator’ value is a way to measure and monitor practitioners' performance without an over-reliance on lag indicators, such as monthly financials. The invention provides a framework on which to base a balanced scorecard in the organization, which means that practitioners will be focusing on improving in the areas that will benefit the long term growth of the firm.

### EXAMPLES

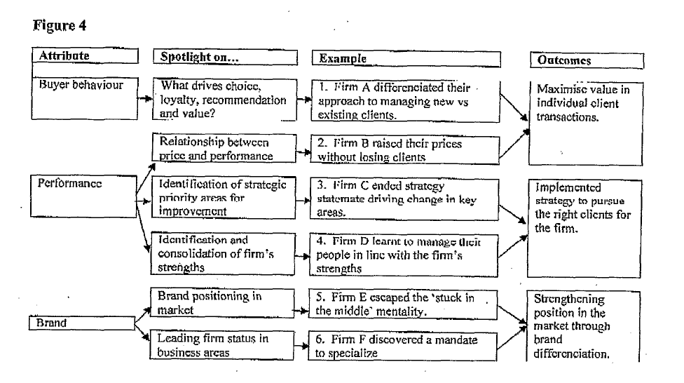

The invention will now be further illustrated by way of several non-limiting examples, which although they are focussed on particular preferred embodiments, should not be construed as limiting in any way. FIG. 4 summarises the elements and outcomes of the Examples that are based on the preferred embodiment depicted in FIG. 1.

In each Example, the evaluation referred to is one according to the present invention and consequently, the data generated and the analysis undertaken is based on the comparisons and analysis as described herein and in particular on comparisons between competitors in relation to one or more organizational attributes or environmental attributes.

### Example 1

### Firm A Differentiated Their Approach to Managing New vs Existing Clients

Firm: Largo national ruin, market leader.

Evaluated Attribute: Buyer behaviour

Information holder selection: Identify and select individuals within organisations which typically purchase the types of services offered by Firm A.

Survey Information related to: The way in which buyers choose which firm to send work to. Differences between non-clients and clients of a firm.

Rating given to Firm in evaluation: Disappointing performance (given market position).

Key component of the evaluation: ‘Comparison of drivers table’ generated by the evaluation. Particular focus on choice, performance, loyalty, recommendation and value. These were used to inform selection of appropriate strategics for client generation and client retention.

Key message identified in evaluation: “While new clients look for reputation—existing clients care more about service!”. (Thus, the key points for Firm A from this evaluation related to environmental attributes which were what new and existing clients look for In a firm. They are both within the ‘buyer behaviour’ subset of environmental attributes.) The message was identified from survey responses to questions about the way in which purchasing decisions are made.

### Explanation

The partners at Firm A were confused. The evaluation results just presented were disappointing, despite the firm having invested considerable time and effort in client management. Their own client surveys were generally very positive.

The first instinct was to reject the findings of the report. But after considerable debate and interrogation of the results, there was eventually no denying that, relative to other firms, under performance was a reality.

Discussion converged on the comparison of drivers table, which showed that what drives clients to choose a firm is not necessarily what drives them to stay loyal. The partnership reasoned that while their system emphasised the importance of client management, its lack of specificity meant that, in building relationships with clients, they defaulted to using the same techniques that won them the work. And while this led to good performance, the overall high level of performance of all firms in the market showed that more was needed.

Over the next few weeks and subsequent workshops a dedicated team developed a communication plan designed to give every partner an understanding of the differences between winning clients and serving clients—and how to manage clients specifically for loyalty and growth.

One partner described the evaluation as the biggest eye-opener she had experienced in 20 years of practice. According to the Marketing Director, the workshops had the most significant impact of any intervention in engaging Firm A's professionals to interact with clients beyond ‘just doing the work’.

### Example 2

### Firm B Raised Their Prices, Without Losing Clients

Firm: Medium-sized firm, with a strong reputation in its core market, competing successfully with larger firms in serving some of Australia's biggest clients.

Evaluated Attributes: Price and performance perceptions

Information holder selection; Current and potential clients.

Survey Information related to: Perception of value received as compared to competitors based on perception of price and performance.

Rating given to Firm in evaluation: A top rating firm in almost every area.

Key component of the evaluation: Price-performance chart and the firm's position were well below the fair value line. This presented an opportunity to align perceptions of value and optimise profitability. (Thus, the key point from this evaluation for Firm B was the organizational attributes of price and performance and specifically price and performance as compared to competitors.)

Key message identified in evaluation: “Clients will always say you charge too much—but ours know that the kind of value we are providing is worth more than below market rates!” The key message was identified by analysing the perceived price and performance received by clients of Firm D in concert with a comparison of price and performance received by clients of Firm B's competitors. It became evident that Firm B was delivering equivalent perceived performance at a much lower price.

### Explanation

For Firm B, the evaluation results brought onto centre stage an issue that had been plaguing partners for some time. They knew their rates were well below the larger firms, but clients wore always telling them their prices were high. The partnership knew they offered as much as or more value than the big firms, but how could they stand their ground on price, let alone match larger firm rates, without losing clients?

The price performance chart put into clear relief just how far below the market Firm B's fees were. As the presentation continued, the partners picked out more and more evidence regarding fees.

The evaluation provided evidence that, if done well, bringing prices closer to those of the larger firms need not result in the loss of clients. As time went on, the Managing Partner's confidence that the firm could pursue opportunities to increase price grew.

Rather than bluntly increasing charge-out rates (risking a client backlash), the partnership identified a number of areas where price could be increased with minimal client resistance. The new pricing strategy was implemented and within six months, profit per partner had leapt forward.

### Example 3

### Firm C Ended Strategy Stalemate, Driving Change in Key Areas

Firm. National firm, regarded by many as ‘second-tier plodders’ in their market.

Evaluated Attribute: Attributes such as service levels, client relationships and technical capabilities.

Information holder selection: Current clients, potential clients and competitors' clients

Survey Information related to: Perceptions of Firm C's performance on a range of attributes compared to perceptions of Firm C's competitors' performance. Importance of various environmental attributes in driving client choice and loyalty.

Rating given to Firm in evaluation: Poor performers—at the lower end of the spectrum on all attributes, relative to competitors.

Key component of the evaluation: Strategic priority matrix based on Firm C's performance on a range of attributes relative to Firm. C's competitors' performance on these attributes mapped against the relative importance of the same attributes—showed that while performance was low overall, there were some areas that were greater priorities for improvement than others. These areas were the ones that a) had the greatest impact on client loyalty and b) where Firm C's performance was well below that of its competitors. (Thus, the key points from the evaluation for Firm C related to certain performance attributes and provided the ability to prioritise them.)

Key message identified in evaluation: “We don't need to continue sitting around debating about how impossible it will be to lift performance on all areas—we need to focus single-mindedly on the ones that matter to clients!”

### Explanation

Like many of their competitors Firm C had progressively become a national firm through the joining of independent state offices, although they had been a late adopter of this strategy. The leadership team had changed a number of times Over the last few years—the primary reason was widely suspected to be frustration with their inability to effect change.

Firm C's Evaluation workshop was tough for the management committee, who were forced to realise that their weak profits were a symptom of the fact that the firm was not a top performer and did not enjoy a great reputation in the eyes of clients—something that many had suspected, but no one wanted to hear.

The partners didn't dispute the formula that good performance attracts good clients, which attracts good staff, which leads to better performance and so on, resulting in superior profits. But the faces of many partners indicated that they still felt paralysed to effect improvements.

As the reality of the firm's poor performance sunk in, the relative importance to clients of the various performance organizational attributes became a focus of discussion. The team resolved that while they couldn't achieve across-the-board improvement right away, they could focus on those areas identified as high priorities for improvement on the strategic priority matrix.

By zoning in on a few attributes where their efforts would make the biggest impact, the leadership team took the all-important first step towards improved performance.

### Example 4

### Firm D Learnt to Manage Their People in Line With the Firm's Strengths

Firm: Successful, single-office firm.

Evaluated Attribute: Attributes such as service levels, client relationships and technical capabilities.

Information holder selection: Current clients, potential clients and competitors' clients

Survey Information related to: Perceptions of Firm D's performance on a range of attributes compared to perceptions of Firm D's competitors' performance. Importance of various environmental attributes in driving client choice and loyalty.

Rating given to Firm in evaluation; Strong all-round performer.

Key component of the evaluation: The firm's strengths identified through the performance charts at an attribute level highlighting than in areas such as responsiveness, client relationships, ease of doing business with, Firm D outperformed it's competitors. (Thus, the key points from the evaluation for Firm D related to certain performance attributes and provided the ability to capitalise on them.)

Key message identified in evaluation: “In order to stay on top, our internal processes must reflect and reinforce these core competencies!” Given that Firm D's performance was already better than their competitors on a number of attributes that were important to clients, the challenge became maintaining this performance rather than developing it.

### Explanation

Firm D's management committee was delighted to hear that their evaluation results indicated that, as they suspected, they ware a top-performing firm in their market, particularly on client focus, where many other firms fell down. But in the midst of self-congratulatory murmurs, the Managing Partner sat back and observed that, while it was nice to obtain independent feedback regarding their strong performance, the strategic priority matrix identified no areas of weakness to address. Aside from using the report for internal morale building, he questioned the value of the evaluation to top-performing firms like his.

He threw the challenge back at the consulting firm, with the seemingly harmless question ‘so what actions should we take?’

Before the consulting firm could respond, his progressive HR Director interjected. With excitement she asserted that if the firm was to. maintain this position it must change its recruitment processes. Recruiting for <<capability set A>> alone, as had been the recent practice, was not the best way to focus on what clients loved best about their firm.

Discussion leapt ahead and w the end it was agreed that in addition to recruitment, the review process, the competency model, and decisions regarding promotion all needed to be updated to reflect a greater emphasis on <<capability set B>>.

The evaluation confirmed something the management committee knew, but it also provided new insight and direction into how their strengths would be best capitalised on. Firm D now had the security of a long-term plan to retain their position as a top-performing firm.

### Example 5

### Firm E Escaped the ‘Stuck in the Middle’ Mentality

Firm: National firm, but well behind the largest firms in the market in terms of size.

Evaluated Attributes: Attributes associated with a brand.

Information holder selection: Potential clients

Survey Information related to: Perceptions of Firm E and Firm E's competitors on attributes such as technical expertise, depth of team, breadth of services, ease of doing business with and caring about clients.

Rating given to Firm in evaluation: Average performer across all areas, though well known in the market.

Key component of the evaluation: Brand positioning map (a map of all competitors brands and their association with attributes such as performance in quality of work, or service level)—placed the firm in the middle of the market, not closely associated with any differentiating attributes. (Thus, the key points from the evaluation for Firm E related to the attribute of brand perception and provided ways to address this.)

Key message identified in evaluation: “How are we going to attract clients when we are trying to be everything to everyone? We need to show we are not a mediocre firm, stuck in the middle!” The buyer behaviour material highlighted that some clients were attracted to a certain set of attributes while other clients were attracted to a different set of attributes. Most firms were clustered around one or other of these groups of attributes. Firm D was positioned between the two clusters and so was not going to be an attractive firm for either group of clients.

### Explanation

Firm E had experienced negative growth over recent years, and the partners had differing views on what should be the firm's strategic direction. The firm's average performance in the evaluation did not come as a great shock, but also was not convincing as the sole reason for the profit stagnation.

When the post-evaluation workshop came round to the brand section and specifically the brand positioning map, a number of partners started probing. Overall, the map illustrated a number of clear strategic positions. One consisted of <<group A>>, in another area of the chare were <<group B>>. Each group was associated with a clear set of attributes. And each position addressed a distinct set of client needs. Firm E's problem was that their brand was somewhere in the middle—weakly associated with each set, but belonging to none. Firm E was seen as a classic ‘Jack of all trades; Master of none’.

The clear, concrete illustration of this finding offered by the brand positioning map brought into sharper focus the debate within the partnership about strategic direction. It provided independent and quantifiable evidence on the firm's current position and a language to discuss options.

While partners had very different views regarding the direction the firm should head, it was unanimously agreed in the workshop that the existing position was untenable. So convinced by the evaluation findings was the management committee that over the next year, they pushed through on a new strategic direction, despite some dissention and fallout in the partnership.

Firm E has never looked back and is now enjoying growth ahead of the market average.

### Example 6

### Firm F Discovered a Mandate to Specialise

Firm: Medium-sized firm, made a major impression in the market over the past decade.

Evaluated Attribute: Leading firm by practice area (eg Audit, Tax)

Information holder selection: Potential clients of Firm F

Survey Information related to: Perception of who were the leading firms in certain areas of practice.

Rating given to Firm in evaluation: A top rating firm across many attributes.

Key component of the evaluation: Brand and leading firm data—showed the firm's attribute of reputation in key parts of the market was very strong, while in other areas, they were not considered a player. (Thus, the key points from the evaluation for Firm F related to the attribute of brand perception and provided ways to capitalise on this.)

Key message identified in evaluation: “The best way to answer ‘where to next?’ is through focusing on our key strengths in the market, rather than on what could be profitable!” While Firm F had achieved a leadership position in a number of practice areas, in other practice areas they were not regarded highly. While Firm F had made efforts to strengthen their leadership position in other areas the findings highlighted these efforts had had no impact and were not required for the firm to retain it's string market position. Hence the firm decided to focus on their key areas of strength rather than continue the battle to develop new areas where they had little expertise.

### Explanation

Over the past few years, Firm F had been grappling with development of the firm's long-term strategy. As a highly successful, relatively new firm, it was easy to feel as though the market was at their feet, though few partners really believed that their success could be sustained ad infinitum without direction. There was little consensus and most debate centred on which business areas there was a market-driven need for and thus would potentially be most profitable to pursue.

This debate was inevitably raised during the evaluation presentation, but the nature of the discussion changed. The evaluation brand and leading firm data gave the leadership team a framework of evidence to discuss the present and visualise the future.

While many business areas had the potential to be profitable, Firm F's success would be to some extent dependent on how strong the market perceived them to be in those areas. The clarity provided by the evaluation data freed the way for the partnership to settle on a direction for Firm F. The leadership team reaffirmed what made the firm special and it became clear that the best move strategically would be to preserve and build on this differentiation rather than trying to satisfy the needs of the market as a whole.

Firm F is currently retaining their strong market position through specialisation in those areas of their business in which the market sees them as key players, rather than chasing ‘maybes’.

### Example Processing System Components And Functionality

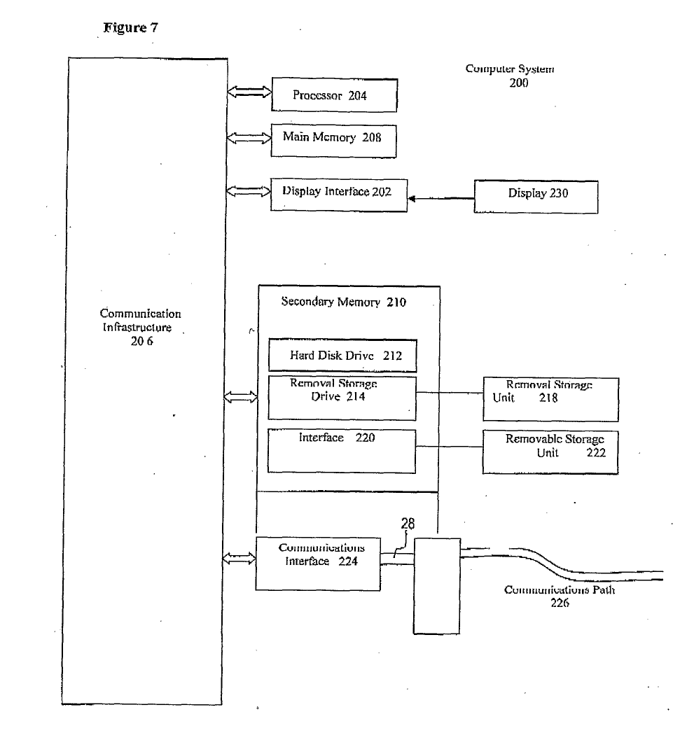

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 7.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which maybe electronic, electromagnetic; optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present Invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

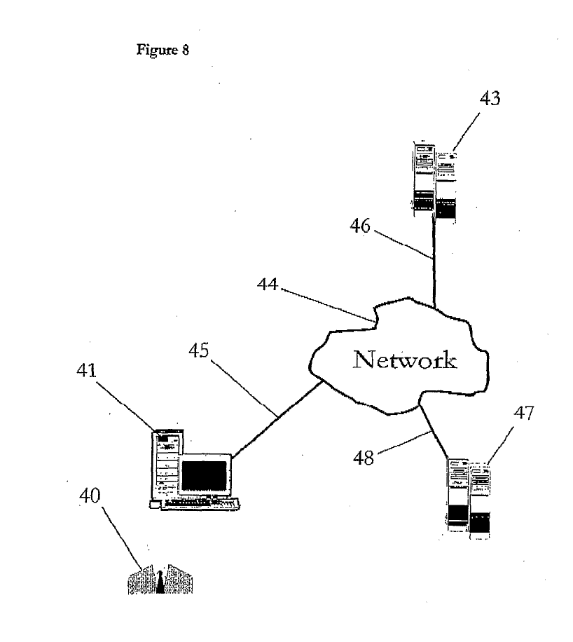

As shown in FIG. 8, in an embodiment of the present invention, the multimedia application operates, tor example, on a network. A user 40, such as an applicant or application processor inputs information, via a terminal 41, such as a personal computer (PC), minicomputer, mainframe computer, microcomputer, telephone device, personal digital assistant (PDA), or other device having a processor and input capability.

As further shown in FIG. 8, in one embodiment, the terminal 41 is coupled to a server 43, such as a PC, minicomputer, mainframe computer, microcomputer, or other device, having a processor and a repository for data or connection to a repository for maintained data, via a network 44, such as the Internet, via couplings 45, 46, such as wired, wireless, or fiber optic connections.

Although preferred embodiments of the invention have been described in the foregoing description, it will be understood that the invention is not limited to the specific embodiments disclosed herein but is capable of numerous modifications by one of ordinary skill in the art. It will be understood that the materials used and technological details may be slightly different or modified from the descriptions herein without departing from the methods and compositions disclosed and taught by the present invention. Many variations and modifications will be apparent to those of ordinary skill in the art. For example, the invention is applicable to a wide range of situations, attributes, environmental attributes, information holders and organizations and it is to be appreciated that other constructions and arrangements are also considered as falling within the scope of the invention.

1. A method of evaluating at least one attribute of an organization, comprising: identifying at least one group of information holders, the group having at least one member who has information about the organization and at least one member who has information about at least one competitor of the organization, wherein the information about the organization and the competitor is related to the attribute; surveying a plurality of information holders within the group to seek responses comprising the information about the organization and the competitor, and analyzing the responses to produce an evaluation.

2. A method according to claim 1 wherein the information holders are independent of the organization.

3. A method according to claim 1 further comprising the step of surveying a plurality of information holders within the group in relation to an environmental attribute relevant to the organization.

4. A method according to claim 1 further comprising the step of providing an award competition for a plurality of organizations in which said awards are based on the results of one or more evaluations.

5. A method according to claim 1 wherein the organization comprises a professional service firm.

6. A method according to claim 1 wherein the analyzing step comprises comparing information received about the organization with that received in relation to at least one competitor.

7. A method according to claim 1 wherein the attribute is intangible.

8. A method according to claim 1 wherein the attribute is an organizational attribute.

9. A method according to claim 8 wherein the attribute is brand.

10. A method according to claim 8 wherein the attribute is service performance.

11. A method according to claim 1 wherein the attribute is an environmental attribute.

12. A method according to claim 11 wherein the attribute is buyer behaviour.

13. A method according to claim 1 further comprising an award competition for a plurality of organisations in which said awards are based on one or more evaluations according to the invention.

14. A method according to claim 1 wherein one or more of the identifying, surveying and analyzing steps are performed electronically.

15. A system or apparatus for evaluating at least one attribute of an organization comprising: a memory system for storing information associated with the evaluation a survey system to conduct a survey of identified information holders; an analysis system to analyse survey responses to produce an evaluation; and optionally a communication system to communicate one or more results of the evaluation to the organization.

16. A system or apparatus according to claim 15 further comprising a processing system capable of identifying at least one group of information holders.

17. A system or apparatus according to claim 15 wherein the memory system comprises a hard disk on a computer in communication with the processing system; and the survey system comprises an internet website and underlying software.

18. A method of generating revenue or consulting work for a consulting enterprise comprising using an evaluation method according to claim 1.

19. A method of generating revenue for a media enterprise comprising running an organization award competition in association with an evaluation method according to claim 1.
